(19) United States
(12) Patent Application Publication
(10) Pub. No.: US 2017/0171320 A1
(43) Pub. Date: Jun. 15, 2017

(54) METHOD, TERMINAL AND DOMAIN NAME SERVER FOR CONNECTING TERMINAL TO SERVER

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Jiahao Zhang, Beijing (CN)

(21) Appl. No.: 15/243,853

(22) Filed: Aug. 22, 2016

Related U.S. Application Data
(63) Continuation of application No. PCT/CN2016/088999, filed on Jul. 6, 2016.

(30) Foreign Application Priority Data
Dec. 15, 2015 (CN) 201510937957.3

(51) Int. Cl. H04L 29/08; H04W 8/22; H04L 29/12

(52) U.S. Cl. CPC H04L 67/141; H04L 61/1511; H04L 61/1541; H04W 8/22

(57) ABSTRACT

A method for connecting a terminal to a server is disclosed, the method includes: a domain name request message is sent to a domain name server by a terminal according to a software identifier of launched application software; a domain name response message sent by the domain name server is received by the terminal, where the domain name response message includes a server domain name matching the software identifier; and a corresponding service server is accessed by the terminal according to the server domain name.

### CROSS-REFERENCES TO RELATED APPLICATIONS

The present application is a continuation application of a PCT application No. PCT/CN2016/088999, filed on Jul. 6, 2016, which claims the priority to Chinese patent application No. 201510937957.3, filed on Dec. 15, 2015 to State Intellectual Property Office, the entire content of both applications is herein incorporated by reference.

### TECHNICAL FIELD

The present disclosure relates to the field of Internet technologies, and more particularly to a method, a terminal and a domain name server for connecting a terminal to a server.

### BACKGROUND

At a high speed development stage of information age, a smart terminal (such as a smart cellphone, a tablet computer, etc.) plays a more and more important role in lives of modern people because of portability, efficient means of communications and presentation of rich information. As compared with a traditional cellphone, a user can install many kinds of application software in a smart terminal according to his/her demand and preference, thereby not only enriching the daily lives, but also bringing a lot of convenience.

As a mobile platform, the smart terminal needs to obtain a domain name of a server while interacting with the Internet, and then acquires required resources from corresponding server according to the domain name. In particular, the server domain name is written in codes of the application software or a configuration file in advance and is locally saved, and the smart terminal directly queries a corresponding domain name locally according to an launched application software to request a server according to this domain name when the smart terminal needs to request the Internet, namely, when it is detected that application software is launched.

But as different types of application software often correspond to different server domain names, or application software of a same type may correspond to a plurality of server domain names in different countries or regions, therefore a large amount of storing space would be occupied if these server domain names are all saved locally.

### SUMMARY

The present disclosure provides a method, a terminal and a domain name server each for connecting a terminal to a server, which can save local storage resources of terminals.

In a first aspect, embodiments of the present disclosure provide a method for connecting a terminal to a server, including:

a domain name request message is sent to a domain name server by a terminal according to a software identifier of launched application software;

a domain name response message sent by the domain name server is received by the terminal, wherein the domain name response message includes a server domain name matching the software identifier; and

a corresponding service server is accessed by the terminal according to the server domain name.

In a second aspect, embodiments of the present disclosure further provide a method for connecting a terminal to a server, including:

a domain name request message sent by a terminal according to a software identifier of launched application software is received by a domain name server; and

a local database is queried by the domain name server to acquire a server domain name matching the software identifier, and a domain name response message is sent to the terminal, to make the terminal access a corresponding service server according to the server domain name.

In a third aspect, embodiments of the present disclosure further provide a terminal including:

at least one processor; and

a memory communicably connected with the at least one processor for storing instructions executable by the at least one processor, wherein execution of the instructions by the at least one processor causes the at least one processor to:

send a domain name request message to a domain name server according to a software identifier of launched application software;

receive a domain name response message sent by the domain name server, wherein the domain name response message includes a server domain name matching the software identifier; and

access a corresponding service server according to the server domain name.

In a fourth aspect, embodiments of the present disclosure further provide a domain name server, including:

at least one processor; and

a memory communicably connected with the at least one processor for storing instructions executable by the at least one processor, wherein execution of the instructions by the at least one processor causes the at least one processor to:

receive a domain name request message sent by a terminal according to a software identifier of launched application software;

query a local database to acquire a server domain name matching the software identifier; and

send a domain name response message to the terminal, to make the terminal access a corresponding service server according to the server domain name.

In a fifth aspect, embodiments of the present disclosure further provide a non-transitory computer-readable storage medium storing executable instructions that, when executed by an electronic device, cause the electronic device to:

send a domain name request message to a domain name server according to a software identifier of launched application software;

receive a domain name response message sent by the domain name server, wherein the domain name response message includes a server domain name matching the software identifier; and

access a corresponding service server according to the server domain name.

In a sixth aspect, embodiments of the present disclosure further provide a non-transitory computer-readable storage medium storing executable instructions that, when executed by an electronic device, cause the electronic device to:

receive a domain name request message sent by a terminal according to a software identifier of launched application software;

query a local database to acquire a server domain name matching the software identifier; and

send a domain name response message to the terminal, to make the terminal access a corresponding service server according to the server domain name.

### BRIEF DESCRIPTION OF THE DRAWINGS

At least one embodiment is illustrated by way of example, and not by limitation, in the figures of the accompanying drawings, wherein elements having the same reference numeral designations represent like elements throughout. The drawings are not to scale, unless otherwise disclosed.

FIGS. 1-3 are flow diagrams illustrating a method for connecting a terminal to a server in accordance with some embodiments;

FIG. 4 is a structural diagram illustrating a terminal for achieving a connection to a server in accordance with some embodiments;

FIG. 5 is a structural diagram illustrating a domain name server for achieving a connection between a terminal and a server in accordance with some embodiments;

FIG. 6 is a functional block diagram illustrating a hardware structure of a terminal in accordance with some embodiments; and

FIG. 7 is a functional block diagram illustrating a hardware structure of a domain name server in accordance with some embodiments.

### DETAILED DESCRIPTION

The disclosure will be described in detail below in combination with the drawings and the embodiments. It should be understood that embodiments described here are only used for explaining the disclosure not used for limiting the disclosure. In addition, it should be noted that for the convenience of description, the drawings only show some structures related to the present disclosure rather than all structures.

### Embodiment 1

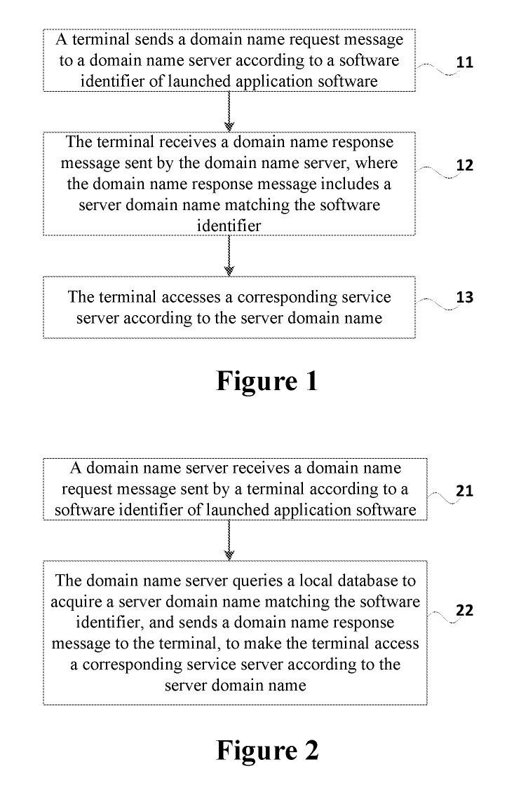

FIG. 1 is a flow diagram illustrating a method for connecting a terminal to a server in accordance with some embodiments. An enforcement object in this embodiment may be a terminal (for example, a smart cellphone, a tablet computer, etc.) for achieving a connection to a server provided in embodiments of the present disclosure. As shown in FIG. 1, the method includes following steps.

In Step 11, a domain name request message is sent to a domain name server by a terminal according to a software identifier of launched application software;

wherein each application software is an application program coming with a system when the terminal is developed, for example, while taking a Letv cellphone as an example, built-in application software of the system includes my Letv, Letv cloud synchronization service, Letv remote locking, built-in browser and other application programs. The software identifier may be a name of an application software installation package or a name of a corresponding application icon; alternatively, when the application software is installed for the first time, corresponding software identifiers are configured for the installed application software by the terminal. For example, unique codes composed of letters, digits, underlines or combinations thereof can be randomly allocated as software identifiers corresponding to the application software, or the application software are numbered according to an installation sequence of the application software, and serial numbers are used as software identifiers corresponding to the application software; alternatively, when developing the terminal, codes are uniformly defined by a developer according to a specification, and the codes are used as software identifiers corresponding to the application software.

In particular, when detecting that application software is launched, the terminal adds a corresponding software identifier into the domain name request message and then the domain name request message is sent to a domain name server; the domain name server acquires the software identifier by analyzing the domain name request message, and then the domain name server queries a local database to acquire a server domain name matching the software identifier, wherein correspondence relationship between the software identifier and the server domain name is pre-stored in the domain name server.

In Step 12, the terminal receives a domain name response message sent by the domain name server, wherein the domain name response message includes the server domain name matching the software identifier.

In Step 13, the terminal accesses a corresponding service server according to the server domain name,

wherein the server domain name is a name of a server and is used for identifying a position of the server. The terminal can position the corresponding service server according to the server domain name, wherein the service server includes an entertainment server for storing resources such as video, music, audio-video and the like, and a navigation server for storing GPS data and the like.

In this embodiment, a terminal sends a domain name request message to a domain name server, so that the domain name server acquires a matched server domain name according to a software identifier of launched application software, and then the terminal accesses a corresponding service server according to the server domain name fed back by the domain name server. In this way, there is no need to locally store a large number of server domain names in the terminal. Therefore, this embodiment can save local storage resources of terminals.

Exemplarily, based on the above-mentioned embodiment, the domain name request message further includes a terminal identifier; and the domain name response message includes a server domain name matching the terminal identifier and the software identifier;

wherein the terminal identifier may be an international mobile equipment identity (IMEI).

In particular, since terminals may be issued in different countries, and different countries may correspond to different server domain names, to facilitate management, the domain name server can group terminal identifiers of all terminals currently issued in different countries according to different countries, for example, terminal identifiers of all terminals issued in the United States are classified into one group, terminal identifiers of all terminals issued in China are classified into one group and so on; and then correspondence relationship between different terminal identifier groups and server domain name groups corresponding to different countries are established. For example, correspondence relationship shown in Table I below may be established:

TABLE I

| Country | Terminal identifier group | Server domain name group |
|---|---|---|
| China | Terminal identifier group 1 | Server domain name group 1 |
| The United | Terminal identifier group 2 | Server domain name group 2 |
| States | | |
| South | Terminal identifier group 3 | Server domain name group 3 |
| Korean | | |
| The United | Terminal identifier group 4 | Server domain name group 4 |
| Kingdom | | |
| . . . | . . . | . . . |

wherein each of the terminal identifier groups includes terminal identifiers of all terminals in an issuing country, and server domain name groups includes server domain names of service servers corresponding to the issuing country. In particular, when application software initiates a domain name request in a terminal, a corresponding country is determined first according to a terminal identifier, and then a matched server domain name is found from a server domain name group of a corresponding country according to a software identifier of the application software.

Also in the above-mentioned embodiment, a terminal can send a domain name request message to a domain name server, so that the domain name server acquires a matched server domain name according to a software identifier of launched application software, and then the terminal accesses a corresponding service server according to the server domain name fed back by the domain name server. In this way, there is no need to locally store a large number of server domain names in the terminal. Therefore, this embodiment can save local storage resources of terminals.

### Embodiment 2

FIG. 2 is a flow diagram illustrating a method for connecting a terminal to a server in accordance with some embodiments. An enforcement object in this embodiment may be a domain name server for connecting a terminal to a server provided in embodiments of the present disclosure. As shown in FIG. 2, the method includes following steps.

In Step 21, a domain name server receives a domain name request message sent by a terminal according to a software identifier of launched application software;

wherein each application software is an application program coming with a system when the terminal is developed, for example, while taking a Letv cellphone as an example, built-in application software of the system includes my Letv, Letv cloud synchronization service, Letv remote locking, built-in browser and other application programs.

The software identifier may be a name of an application software installation package or a name of a corresponding application icon; alternatively, when the application software is installed for the first time, corresponding software identifiers are configured for the installed application software by the terminal. For example, unique codes composed of letters, digits, underlines or combinations thereof can be randomly allocated as software identifiers corresponding to the application software, or the application software are numbered according to an installation sequence of the application software, and serial numbers are used as software identifiers corresponding to the application software; alternatively, when developing the terminal, codes are uniformly defined by a developer according to a specification, and the codes are used as software identifiers corresponding to the application software.

In particular, when detecting that application software is launched, the terminal adds a corresponding software identifier into the domain name request message and then the domain name request message is sent to a domain name server; the domain name server acquires the software identifier by analyzing the domain name request message, and then the domain name server queries a local database to acquire a server domain name matching the software identifier, wherein correspondence relationship between the software identifier and the server domain name is pre-stored in the domain name server.

In Step 22, the domain name server queries a local database to acquire a server domain name matching the software identifier, and sends a domain name response message to the terminal, to make the terminal access a corresponding service server according to the server domain name,

wherein the server domain name is a name of a server and is used for identifying a position of the server. The terminal can position the corresponding service server according to the server domain name, wherein the service server includes an entertainment server for storing resources such as video, music, audio-video and the like, and a navigation server for storing GPS data and the like.

In this embodiment, by storing a server domain name matching the software identifier in the domain name server, a terminal sends a domain name request message to a domain name server when detecting the launched application software, so that the domain name server can acquire the matched server domain name according to the software identifier of the launched application software, and then the terminal accesses a corresponding service server according to the server domain name fed back by the domain name server. In this way, there is no need to locally store a large number of server domain names in the terminal. Therefore, this embodiment can save local storage resources of terminals.

Exemplarily, based on the above-mentioned embodiment, since terminals may be issued in different countries, and different countries may correspond to different server domain names. To facilitate management, the domain name server can group terminal identifiers of currently issued terminals according to different countries, and then establish correspondence relationships between terminal identifier groups and server domain name groups. For example, the correspondence relationships shown in Table I may be established. When the terminal sends the domain name request message, the terminal identifier is added into the domain name request message, and then the domain name request message is sent to the domain name server together with the software identifier. In particular, the method further includes following steps.

The domain name server groups terminal identifiers of currently issued terminals according to a predetermined rule (for example, different countries), and establishes correspondence relationships between each terminal identifier groups and each server domain name groups.

Accordingly, querying a local database by the domain name server to acquire a server domain name matching the software identifier may include:

querying the local database by the domain name server to acquire a server domain name group matching the terminal identifier, wherein the server domain name group includes at least one server domain name; and

acquiring, by the domain name server, the server domain name matching the software identifier from the server domain name group;

wherein the terminal identifier may be an IMEI code. In particular, when the domain name server acquires the server domain name, a country corresponding to the terminal identifier is determined first according to the terminal identifier, and then a server domain name is randomly selected from server domain names corresponding to the country and is returned to the terminal, or all server domain names corresponding to the country are fed back to the terminal for the terminal to select.

Also in the above-mentioned embodiment, by storing a server domain name matching the software identifier in the domain name server, a terminal sends a domain name request message to a domain name server when detecting an launched application software, so that the domain name server can acquire the matched server domain name according to the software identifier of the launched application software, and then the terminal accesses a corresponding service server according to the server domain name fed back by the domain name server. In this way, there is no need to locally store a large number of server domain names in the terminal. Therefore, the above-mentioned embodiment can save local storage resources of terminals as well.

### Embodiment 3

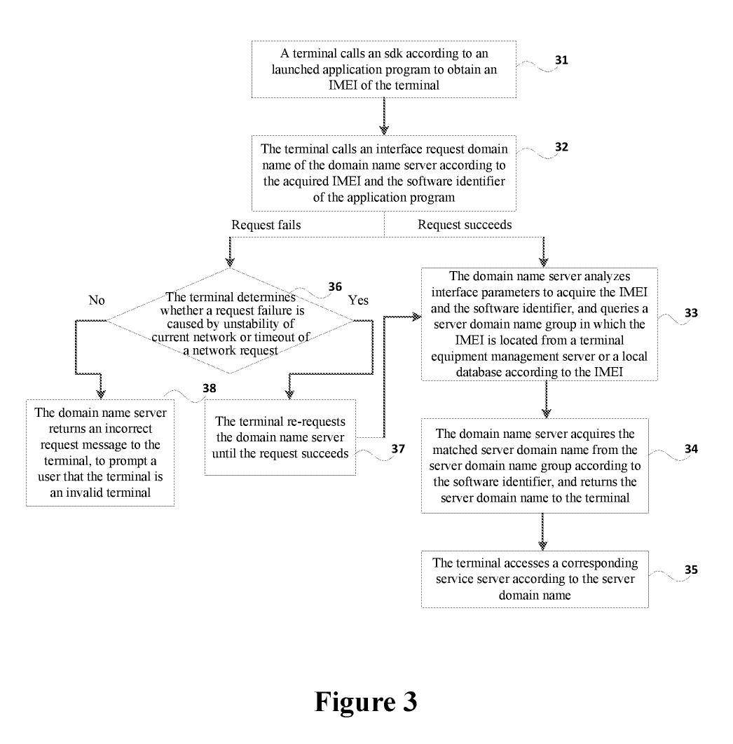

FIG. 3 is a flow diagram illustrating a method for connecting a terminal to a server in accordance with some embodiments. A terminal and a domain name server are used as enforcement objects of this embodiment, and an acquisition operation of a server domain name is completed by instruction interacting of the terminal and the domain name server. As shown in FIG. 3, the method includes following steps.

In step 31, the terminal calls a sdk according to an launched application program to obtain an IMEI of the terminal;

wherein the sdk is a program for acquiring the IMEI of the terminal and is developed in advance by program developers. When an application program in the terminal is launched, it is attempted to acquire the IMEI of the terminal by calling the sdk, incorrect information “acquisition of IMEI fails” is returned to the terminal if information about the IMEI is not acquired, and the IMEI is returned to the terminal if the information about the IMEI is successfully acquired.

In Step 32, the terminal calls an interface request domain name of the domain name server according to the acquired IMEI and the software identifier of the application program.

In particular, if the domain name server is successfully requested, steps 33-35 are executed; and if the server is unsuccessfully requested, step 36 is executed.

In Step 33, the domain name server analyzes interface parameters to acquire the IMEI and the software identifier, and queries a server domain name group in which the IMEI is located from a terminal equipment management server or a local database according to the IMEI.

In Step 34, the domain name server acquires a matched server domain name from the server domain name group according to the software identifier, and returns the server domain name to the terminal.

In Step 35, the terminal accesses a corresponding service server according to the server domain name.

In Step 36, the terminal determines whether a request failure is caused by un-stability of current network or timeout of a network request.

If the current network is unstable or the network request has timed out, step 37 is executed; and if the request failure is not caused by a problem of the current network, then there may be a possibility that the information about the IMEI is not stored in the domain name server since the IMEI of the terminal is invalid, and step 38 is executed.

In Step 37, the terminal re-requests the domain name server until the request succeeds, and step 33 is executed.

In Step 38, the domain name server returns an incorrect request message to the terminal to prompt a user that the terminal is an invalid terminal.

### Embodiment 4

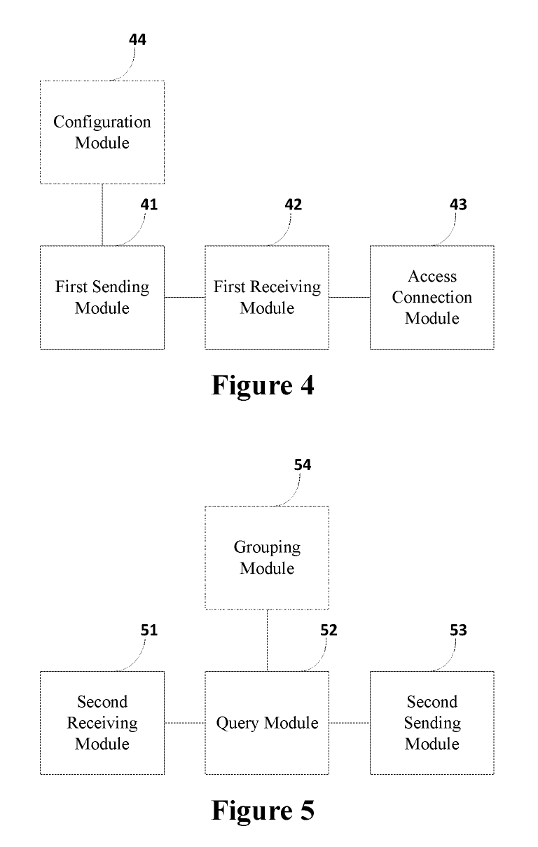

FIG. 4 is a structural diagram illustrating a terminal for achieving a connection to a server in accordance with some embodiments, as shown in FIG. 4, the terminal includes: a first sending module 41, a first receiving module 42 and an access connection module 43;

wherein the first sending module 41 is configured to send a domain name request message to a domain name server according to a software identifier of launched application software;

the first receiving module 42 is configured to receive a domain name response message sent by the domain name server, wherein the domain name response message includes a server domain name matching the software identifier; and

the access connection module 43 is configured to access a corresponding service server according to the server domain name.

The terminal for achieving a connection to a server in embodiments of the present disclosure is configured to execute the method for connecting a terminal to a server in the above-mentioned embodiment, and has similar technical principles and generated technical effects, which are not described in detail here.

Exemplarily, based on the above-mentioned embodiment, the domain name request message further includes a terminal identifier; and the domain name response message includes a server domain name matching the terminal identifier and the software identifier.

Exemplarily, based on the above-mentioned embodiment, the terminal further includes: a configuration module 44,

wherein the configuration module 44 is configured to configure corresponding software identifiers for installed application software before the terminal sends the domain name request message to the domain name server according to the software identifier of the launched application software.

Exemplarily, based on the above-mentioned embodiment, the terminal identifier is an international mobile equipment identity (IMEI) code.

The terminal for achieving a connection to a server in the above-mentioned embodiment is also configured to execute the method for connecting a terminal to a server in the above-mentioned embodiment, and has similar technical principles and generated technical effects, which are not described in detail here.

### Embodiment 5

FIG. 5 is a structural diagram illustrating a domain name server for achieving a connection between a terminal and a server in accordance with some embodiments, as shown in FIG. 5, the server including: a second receiving module 51, a query module 52 and a second sending module 53;

wherein the second receiving module 51 is configured to receive a domain name request message sent by a terminal according to a software identifier of launched application software;

the query module 52 is configured to query a local database to acquire a server domain name matching the software identifier; and

the second sending module 53 is configured to send a domain name response message to the terminal, to make the terminal access a corresponding service server according to the server domain name.

The domain name server for achieving a connection between a terminal and a server in embodiments of the present disclosure is configured to execute the method for connecting a terminal to a server in the above-mentioned embodiment, and has similar technical principles and generated technical effects, which are not described in detail here.

Exemplarily, based on the above-mentioned embodiment, the domain name request message further includes a terminal identifier.

The query module 52 is further configured for querying the local database to acquire a server domain name group matching the terminal identifier, wherein the server domain name group includes at least one server domain name; and acquiring a server domain name matching the software identifier from the server domain name group.

Exemplarily, based on the above-mentioned embodiment, the domain name server further includes: a grouping module 54;

wherein the grouping module 54 is configured to group terminal identifiers of currently issued terminals according to a predetermined rule before the domain name server queries the local database to acquire a server domain name group matching the terminal identifier, and establish correspondence relationships between terminal identifier groups and server domain name groups.

Exemplarily, based on the above-mentioned embodiment, the terminal identifier is an international mobile equipment identity (IMEI) code.

The domain name server for achieving a connection between a terminal and a server in the above-mentioned embodiment is configured to execute the method for connecting a terminal to a server in the above-mentioned embodiment, and has similar technical principles and generated technical effects, which are not described in detail here.

### Embodiment 6

Embodiments of the present disclosure provide a non-transitory computer-readable storage medium in which a computer executable instruction is stored, wherein the computer executable instruction is used for executing a method at a terminal side for connecting a terminal to a server in any of the above-mentioned method embodiments.

### Embodiment 7

Embodiments of the present disclosure provide a non-transitory computer-readable storage medium in which a computer executable instruction is stored, wherein the computer executable instruction is used for executing a method at a domain name server side for connecting a terminal to a server in any of the above-mentioned method embodiments.

### Embodiment 8

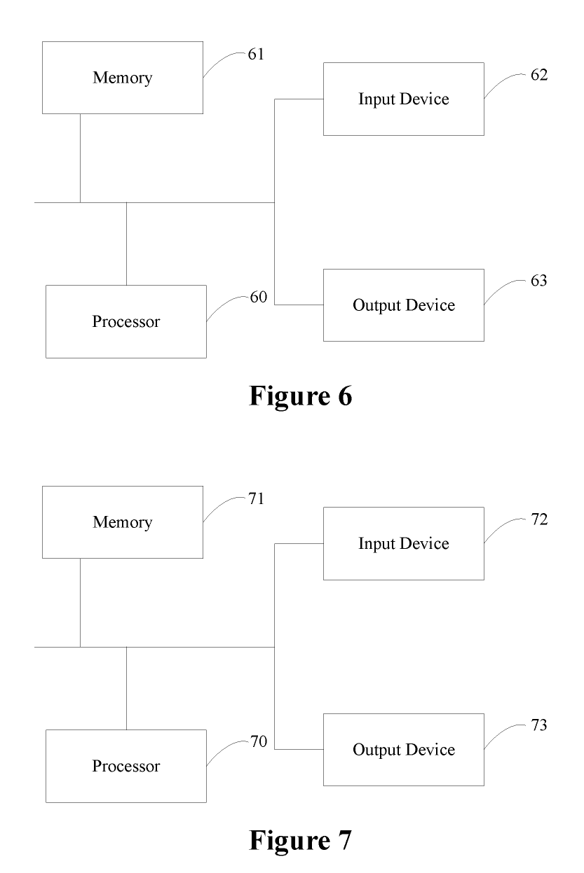

FIG. 6 is a functional block diagram illustrating a hardware structure of a terminal in accordance with some embodiments, referring to FIG. 6, the terminal includes:

at least one processor 60 and a memory 61, wherein one processor 60 is taken as an example in FIG. 6.

The terminal may further include: an input device 62 and an output device 63.

The processor 60, the memory 61, the input device 62 and the output device 63 of the terminal can be connected by a bus or in other manners, and a connection through the bus is taken as an example in FIG. 6.

As a non-transitory computer readable storage medium, the memory 61 may be configured to store non-transitory software programs, non-transitory computer executable programs and modules, (for example, first sending module 41, first receiving module 42 and access connection module 43 shown in FIG. 4), such as program instructions/modules corresponding to the method for connecting a terminal to a server in embodiments of the present disclosure. The processor 60 executes function application and data processing of the server by operating software programs, instructions and modules stored in the memory 61, namely, the method for connecting a terminal to a server in the above-mentioned method embodiment is realized.

The memory 61 may include a program storage area and a data storage area, wherein the program storage area can store an operating system and an application program required by at least one function; and the data storage area can store data created by use of the terminal equipment. In addition, the memory 61 may include a high-speed random access memory, and may further include a non-transitory memory such as at least one magnetic disk storage device, a flash memory device or other non-transitory solid-state storage devices. In some examples, the memory 61 may include memories remotely arranged relative to the processor 60, wherein these remote memories may be connected to the terminal through a network. The embodiment of the above-mentioned network includes but are not limited to an Internet, an Intranet, a local area network, a mobile communication network and a combination thereof.

The input device 62 may be configured to receive input digit or character information, and generate key signal input related to user setting and function control of the terminal. The output device 63 may include a display equipment such as a display screen.

The at least one module is stored in the memory 61, and executes the method for connecting a terminal to a server in any of the above-mentioned method embodiments when executed by the at least one processor 60.

### Embodiment 9

FIG. 7 is a functional block diagram illustrating a hardware structure of a domain name server in accordance with some embodiments, referring to FIG. 7, the domain name server includes:

at least one processor 70 and a memory 71, wherein one processor 70 is taken as an example in FIG. 7.

The domain name server may further include: an input device 72 and an output device 73.

The processor 70, the memory 71, the input device 72 and the output device 73 of the domain name server can be connected by a bus or other manners, and a connection through the bus is taken as an example in FIG. 7.

As a non-transitory computer readable storage medium, the memory 71 may be configured to store non-transitory software programs, non-transitory computer executable programs and modules, such as program instructions/modules corresponding to the method for connecting a terminal to a server in embodiments of the present disclosure (for example, second receiving module 51, query module 52 and second sending module 53 shown in FIG. 5). The processor 70 executes function application and data processing of the server by operating software programs, instructions and modules stored in the memory 71, namely, the method for connecting a terminal to a server in the above-mentioned method embodiment is realized.

The memory 71 may include a program storage area and a data storage area, wherein the program storage area can store an operating system and an application program required by at least one function; and the data storage area can store data created by use of the terminal equipment. In addition, the memory 71 may include a high-speed random access memory, and may further include a non-transitory memory such as at least one magnetic disk storage device, a flash memory device or other non-transitory solid-state storage devices. In some examples, the memory 71 may include memories remotely arranged relative to the processor 70, wherein these remote memories may be connected to the terminal equipment through a network. The embodiments of the above-mentioned network includes but are not limited to an Internet, an Intranet, a local area network, a mobile communication network and a combination thereof.

The input device 72 may be configured to receive input digit or character information, and generate key signal input related to user setting and function control of the terminal. The output device 73 may include a display equipment such as a display screen.

The at least one module is stored in the memory 71, and executes the method for connecting a terminal to a server in any of the above-mentioned method embodiments when executed by the at least one processor 70.

The above-mentioned product can execute the method provided in embodiments of the present disclosure, and has corresponding function modules for executing the method and beneficial effects. See the method provided in embodiments of the present disclosure for technical details not described in this embodiment in detail.

The electronic equipment in embodiments of the present disclosure exists in various forms, including but not limited to:

(1) mobile telecommunication device. A device of this kind has a feature of mobile communicating function, and has a main object of providing voice and data communication. Devices of this kind include smart phone (such as iphone), multi-media cell phone, functional cell phone, low-end cell phone and the like;

(2) ultra mobile personal computer device. A device of this kind belongs to a category of personal computer, has functions of computing and processing, and generally has a feature of mobile internet access. Devices of this kind include PDA, MID, UMPC devices and the like, such as ipad;

(3) portable entertainment device. A device of this kind can display and play multi-media content. Devices of this kind include audio and video player (such as ipod), handheld game player, e-book, intelligent toy and portable vehicle navigation device;

(4) server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;

(5) other electronic devices having data interacting functions.

Device embodiments described above are only illustrative, elements in the device embodiments illustrated as separated components may be or may not be physically separated, and components shown as elements may be or may not be physical elements, that is, the components may be located in one position, or may be distributed on a plurality of network units. Part or all of modules in the components may be selected according to actual requirements to achieve purpose of solutions in embodiments, which can be understood and perform by those of ordinary skill in the art without inventive works.

By descriptions of above embodiments, those skilled in the art can clearly learn that various embodiments can be achieved with aid of software and necessary common hardware platform, or with aid of hardware. Based on such an understanding, essential of above technical solutions or, in other words, parts of above technical solutions contributing to the related art may be embodied in form of software products which can be stored in a computer readable storage medium, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement dose not make essential of corresponding technical solutions depart from spirits and scope of technical solutions of various embodiments.

What is claimed is:

1. A method for connecting a terminal to a server, comprising:
at a terminal:
sending, by the terminal, a domain name request message to a domain name server according to a software identifier of launched application software;
receiving, by the terminal, a domain name response message sent by the domain name server, wherein the domain name response message includes a server domain name matching the software identifier; and
accessing, by the terminal, a corresponding service server according to the server domain name.

2. The method according to claim 1, wherein the domain name request message further comprises a terminal identifier, and wherein the domain name response message includes a server domain name matching the terminal identifier and the software identifier.

3. The method according to claim 1, before the terminal sends the domain name request message to the domain name server according to the software identifier of the launched application software, further comprising:
configuring, by the terminal, corresponding software identifiers for each installed application software.

4. The method according to claim 2, wherein the terminal identifier is an international mobile equipment identity IMEI code.

5. A method for connecting a terminal to a server, executed by a server, comprising:
at a server:
receiving, by a domain name server, a domain name request message sent by a terminal according to a software identifier of launched application software; and
querying a local database by the domain name server to acquire a server domain name matching the software identifier, and sending the domain name response message to the terminal, to make the terminal access a corresponding service server according to the server domain name.

6. The method according to claim 5, wherein the domain name request message further comprises a terminal identifier, and wherein querying a local database by the domain name server to acquire a server domain name matching the software identifier comprises:
querying the local database by the domain name server to acquire a server domain name group matching the terminal identifier, wherein the server domain name group includes at least one server domain name, and
acquiring, by the domain name server, the server domain name matching the software identifier from the server domain name group.

7. The method according to claim 6, before the domain name server queries the local database to acquire a server domain name group matching the terminal identifier, further comprising:
grouping, by the domain name server, terminal identifiers of currently issued terminals according to a predetermined rule; and
establishing correspondence relationships between each terminal identifier groups and each server domain name groups.

8. The method according to claim 6, wherein the terminal identifier is an international mobile equipment identity IMEI code.

9. A terminal, comprising:
at least one processor; and
a memory communicably connected with the at least one processor for storing instructions executable by the at least one processor, wherein execution of the instructions by the at least one processor causes the at least one processor to:
send a domain name request message to a domain name server according to a software identifier of launched application software;
receive a domain name response message sent by the domain name server, wherein the domain name response message includes a server domain name matching the software identifier; and
access a corresponding service server according to the server domain name.

10. The terminal according to claim 9, wherein the domain name request message further comprises a terminal identifier, and wherein the domain name response message comprises a server domain name matching the terminal identifier and the software identifier.

11. The terminal according to claim 9, wherein, the execution of the instructions by the at least one processor further causes the at least one processor to:
configure corresponding software identifiers for various installed application software before the terminal sends the domain name request message to the domain name server according to the software identifier of the launched application software.

12. The terminal according to claim 10, wherein the terminal identifier is an international mobile equipment identity IMEI code.

13. A domain name server, comprising:
at least one processor; and
a memory communicably connected with the at least one processor for storing instructions executable by the at least one processor, wherein execution of the instructions by the at least one processor causes the at least one processor to:
receive a domain name request message sent by a terminal according to a software identifier of launched application software;
query a local database to acquire a server domain name matching the software identifier; and
send a domain name response message to the terminal, to make the terminal access a corresponding service server according to the server domain name.

14. The domain name server according to claim 13, wherein the domain name request message further comprises a terminal identifier, and wherein the execution of the instructions by the at least one processor further causes the at least one processor to:
query the local database to acquire a server domain name group matching the terminal identifier, wherein the server domain name group includes at least one server domain name; and
acquire the server domain name matching the software identifier from the server domain name group.

15. The domain name server according to claim 14, wherein, the execution of the instructions by the at least one processor further causes the at least one processor to:
group terminal identifiers of currently issued terminals according to a predetermined rule before the domain name server queries the local database to acquire a server domain name group matching the terminal identifier; and
establish correspondence relationships between terminal identifier groups and server domain name groups.

16. The domain name server according to claim 14, wherein the terminal identifier is an international mobile equipment identity IMEI code.
